(19) United States
(12) Patent Application Publication
(10) Pub. No.: US 2010/0007887 A1
(43) Pub. Date: Jan. 14, 2010

(54) GLAZING INSPECTION

(75) Inventor: Simon Peter Aldred, Lancashire (GB)

Correspondence Address: BUCHANAN, INGERSOLL & ROONEY PC, POST OFFICE BOX 1404, ALEXANDRIA, VA, 22313-1404, US

(73) Assignee: Pilkington Group Limited, St. Helens (GB)

(21) Appl. No.: 12/523,642

(22) PCT Filed: Feb. 15, 2008
(86) PCT No.: PCT/GB2008/050099

§ 371 Date: Jul. 17, 2009

(30) Foreign Application Priority Data
Feb. 15, 2007 (GB) 0702937.4

(51) Int. Cl. G01N 21/958

(52) U.S. Cl. 356/432

(57) ABSTRACT

A method of inspecting the fragmentation pattern of a single ply of toughened glass, following a fragmentation test carried out in accordance with ECE R43 involves illuminating a first portion of the ply of glass in transmission using a strip light source located on a first side of the transparent support. An image of the first portion of the ply of glass is captured using an image capture device located on a second side of the transparent support means, aligned with and fixed in a relative position to the strip light source. A series of images of the glass are collected and analyzed to produce an image of the fragmentation pattern. Imaging can be performed using an apparatus for carrying out the imaging.

The present invention relates to apparatus for inspecting glazings, in particular, apparatus for detecting variations in transmission of light through a glazing.

Although the float glass process produces high quality flat glass, subsequent processing can induce defects within the glass. These defects affect the optical quality of the glazing, and are a particular issue for glass used in automotive glazings and so such glazings are inspected during production for various defects that may affect the optical quality of the finished glazing product. For example, the glass may contain inclusions or faults, such as nickel sulphide inclusions or bubbles. Alternatively, the glass may have faults acquired through processing, for example, edge faults, brillantatura and shiners from the cutting and grinding processes used to cut the glass to size, and distortion, thickness and curvature variations from the firing and bending processes used to shape the glass.

Optical inspection methods may also be used to determine whether a glazing meets various safety standards. In the case of glass used to make windscreens and backlights, a double or secondary image is seen when viewing an object through the glass. The effect is caused by thickness variations within the glass, present in varying degrees, and due to the shape of the screen and possible shaping errors introduced during manufacture. Under ECE R43, the angle between the primary and secondary images must lie below a certain limit, and glazings are tested using various optical inspection methods.

As well as using optical inspection methods to determine whether a glazing meets optical standards, such methods may be used to help determine whether a glazing meets impact resistance standards.

Under ECE R43, toughened glass for automotive use is toughened to the extent that it passes the fragmentation test for uniformly toughened glass panes specified in ECE R43 (the relevant safety standard in Europe for automotive glazings) in which the number of fragments in any 5 cm×5 cm square is not less than 40 or more than 400, or in the case of a glazing not more than 3.5 mm thick, 450. In order to measure the number of fragments, the area of the largest fragment and the length of the longest fragment in the test region, a single ply of glass is placed on a sheet of photosensitive paper before the impact test is carried out. Once the glass has been fractured, the photosensitive paper is exposed to light, creating a blueprint image of the fragments created. The number, shape and size of fragments in selected region are then ascertained. This may be done by eye, with an operator counting and measuring the fragments, or using an automated system, such as that disclosed by Ford Motor Co. in Glass Processing Days, 13-15 Sep. 1997. The use of either blueprint method however is time consuming, and so is therefore only practical for use in offline testing.

An alternative method of imaging and processing the test data is disclosed in U.S. Pat. No. 6,766,046. A light source is positioned above a ply of glass supported on a paper screen held on a transparent guide sheet. A camera having a line sensor is positioned underneath the screen, to detect the image of the fragments projected onto the screen by the light source. Either the glass or the camera may be moved to ensure that the entire area of the ply of glass is scanned. The light source may be a point source, combined with a condensing lens, or an array of light sources.

The automation of the data collection and image processing reduces the amount of time necessary to determine whether a ply of glass has passed or failed the fragmentation test. However, the use of the screen (where the camera records the screen image rather than a direct image from the glass) causes difficulties when glass having a low light transmission is tested. In U.S. Pat. No. 6,766,046, low light transmission is overcome by employing a photosensor to determine the light transmission of the glass so that the exposure time needed by the camera to record the image on the screen may be adjusted accordingly. However, for low light transmission glass, this increases the amount of time required for data acquisition. In order for an automated system to be viable in a production situation, the image capture ideally needs to be completed within a three minute time window.

There is therefore a need for an optical inspection system allows testing and measurement for the fragmentation test under ECE R43 to be carried within a short time-frame, for both high and low light transmission glasses.

The present invention aims to address these problems by providing a method of inspecting the fragmentation pattern of a single ply of toughened glass, following a fragmentation test carried out in accordance with ECE R43, the method comprising positioning the ply of glass in contact with a flat transparent support means; illuminating a first portion of the ply of glass in transmission using a strip light source located on a first side of the transparent support means; capturing the image of the first portion of the ply of glass using an image capture device, the image capture device being located on a second side of the transparent support means, aligned with and fixed in a relative position to the strip light source; and moving the strip light source and the image capture device together along the length of the ply of glass, capturing an image from at least a second portion of the ply of glass.

By providing the image capture device and light source in a fixed relationship, and imaging the glass directly without the use of a screen, a high resolution image of the fragmentation pattern can be obtained on even low light transmission glasses.

Preferably, sufficient images are captured to determine the fragmentation pattern over the entire ply of glass.

Preferably, the image capture device is a line scan camera.

Preferably, the strip light source is one of a fluorescent tube or a linear array of light emitting diodes or a linear array of incandescent bulbs.

Preferably, the movement of the light source and the image capture device is in tandem. Preferably, the movement of the light source and the image capture device is continuous, and the images of the first and at least second portion of the ply of glass are captured sequentially.

The present invention also provides optical inspection apparatus adapted to inspect the fragmentation pattern of a single ply of toughened glass, following a fragmentation test carried out in accordance with ECE R43, the apparatus comprising a support frame having a flat transparent support means for supporting a ply of glass; a strip light source located on a first side of the transparent support means; an image capture device being located on a second side of the transparent support means, aligned with and fixed in a relative position to the strip light source; and drive means mounted on the support frame to move the strip light source and the image capture device together along the length of the ply of glass.

Preferably, the image capture device is a line scan camera.

Preferably, the strip light source is one of a fluorescent tube or a linear array of light emitting diodes or a linear array of incandescent bulbs.

Preferably, the light transmittance of the glass imaged, for glass in the thickness range 3 to 8 mm, is 10% to 90%, more preferably 10% to 40%, measured using CIE Illuminant A.

The invention will now be described by way of example only, and with reference to the accompanying drawings in which:

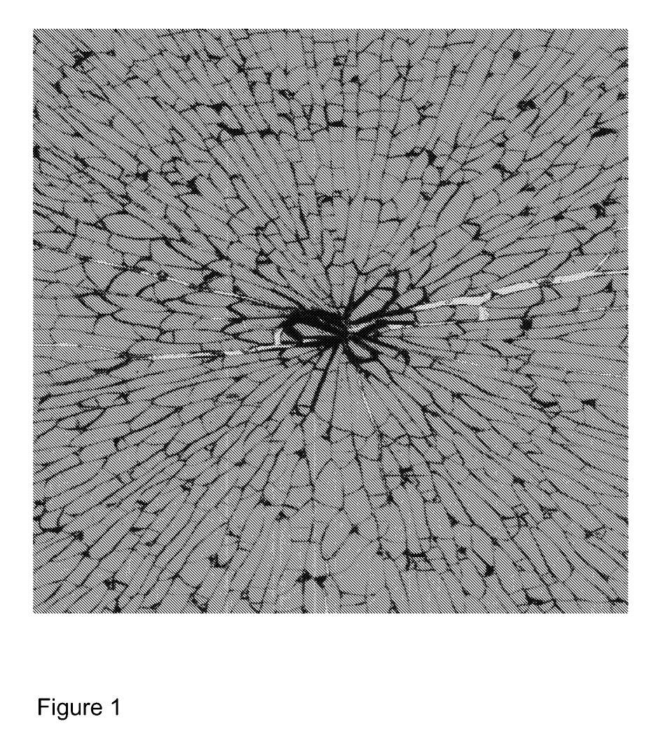

FIG. 1 is an image of a fragmentation pattern;

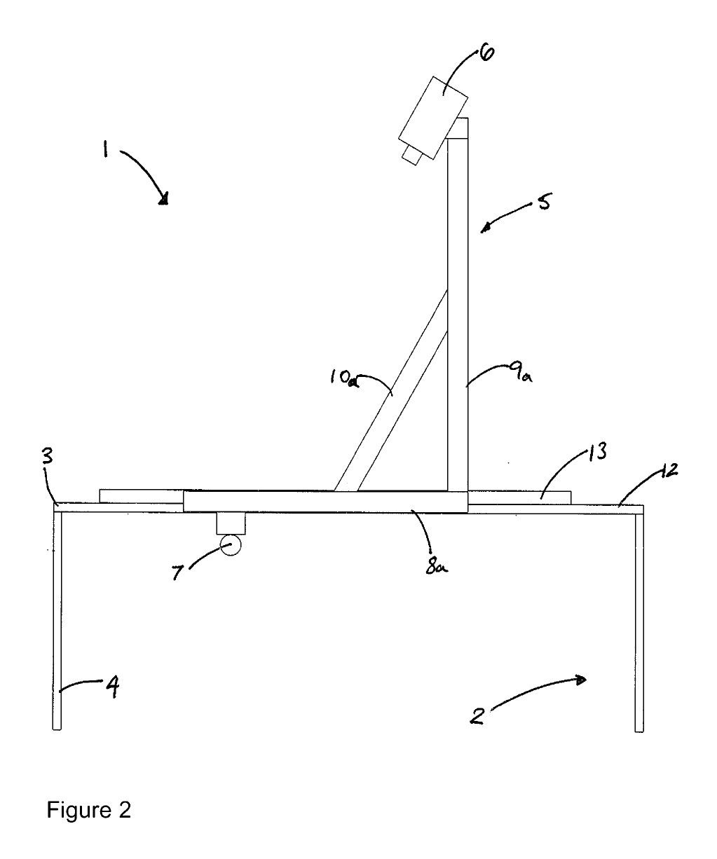

FIG. 2 is a schematic cross-section of an apparatus for imaging fragmentation patterns in accordance with the present invention;

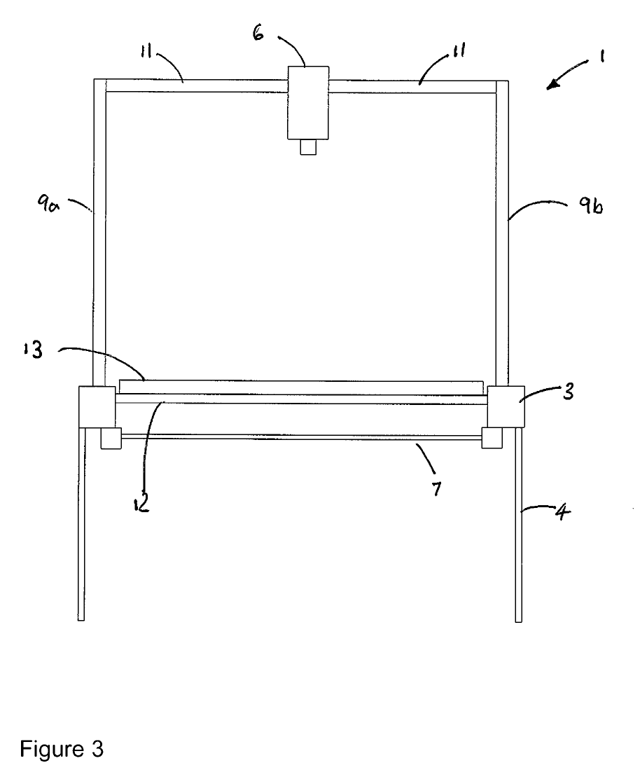

FIG. 3 is a schematic elevation of the apparatus of FIG. 2; and

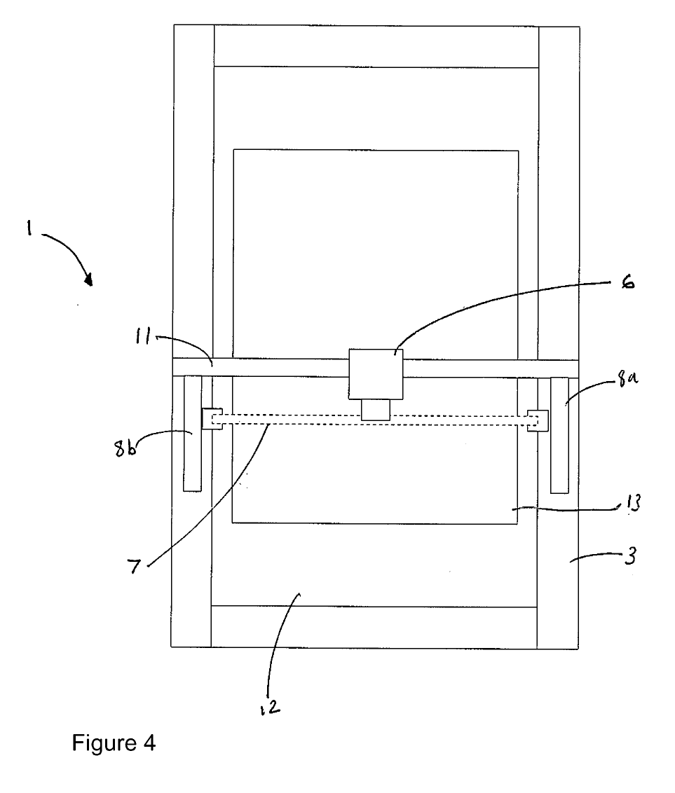

FIG. 4 is a schematic plan view of the apparatus of FIG. 1.

In order to overcome the difficulties associated with imaging fragmentation patterns in limited timescales and for low light transmission glazings, the present invention adopts the approach of imaging the fragmentation pattern directly, rather than via a blueprint image or a screen.

FIG. 1 shows a fragmentation pattern in a single ply of toughened glass. In order to create the pattern, a curved, toughened ply of glass was first taped (to ensure that all the fragments are held together after impact) and then an impact was made. In accordance with ECE R43, a spring loaded centre punch was used to create the impact in the centre of the glass. This caused the glass to fragment, and the curvature in the ply relaxed. The test was carried out on a ply of glass taken from a production line, and the fragmentation pattern imaged in accordance with the invention, as described below.

FIG. 2 shows a schematic cross-section of an apparatus for imaging such fragmentation patterns in accordance with the present invention. The imaging apparatus 1 comprises a support frame 2 comprising a rectangular frame 3 mounted on four legs 4. The rectangular frame 4 carries a moveable imaging rig 5 on which a line scan camera 6 and fluorescent tube polychromatic (white light) light source 7 are mounted. The imaging rig 5 comprises an opposing pair of base portions 8a 8b, each having a vertical support 9a 9b mounted at one end, and braced from the base portion 8a 8b by a strut 10a 10b. A horizontal support 11 (not shown) separates the two vertical supports 9a 9b at their upper ends. The line scan camera 6 is fixedly mounted on the horizontal support 11, at a position equidistant from the upper ends of both vertical supports 9a 9b. The fluorescent tube light source 7 is mounted underneath the transparent support means 3, running between the ends of the base portions 8a 8b remote from the vertical supports 9a 9b. The line scan camera 6 is mounted on the horizontal support 11 in an angled manner so to image the fluorescent tube light source in the centre of its field of view. The line scan camera 6 and the fluorescent tube light source 7 are therefore mounted in a fixed relationship.

In order to carry the imaging rig 5, the long sides of the rectangular frame 3 are provided with drive means (not shown), mounted on the frame, which engage with the base portions 8a 8b. These drive means enable the imaging rig 5 to travel from a first position at one short side of the rectangular frame 3 to a second position at the other. The drive means comprise a pair of continuous, motor driven belts, stretching along the length of the rectangular frame 3. The rectangular frame 3 is also provided with a transparent support surface 12, which carries the ply of glass 13 to be imaged. The transparent support means are positioned such that the fluorescent tube light source is positioned on a first side (underneath) of the support and the line scan camera is positioned on a second side (above) of the support.

FIG. 3 is a schematic elevation of the imaging apparatus 1, showing the positioning of the horizontal support 11, the line scan camera 6 and the fluorescent tube light source 7 more clearly. FIG. 4 is a schematic plan view of the imaging apparatus of FIG. 2, illustrating the position of the ply of glass 13 to be imaged during a data collection run. In this FIG., the imaging rig 5 has travelled approximately two-thirds of the length of the ply of glass 13.

The operation of the imaging apparatus will now be described. Following a fragmentation test carried out in accordance with ECE R43, a ply of glass 13 is placed onto the transparent support surface 12 whilst the imaging rig 5 is in the first position at one short side of the rectangular frame 3. Once the ply of glass 13 is in position, the data collection run begins. The drive means cause the imaging rig 5 to advance along the length of the rectangular frame 3, whilst the fluorescent tube light source 7 illuminates the ply of glass 13. Simultaneously, the line scan camera 6 scans the illuminated ply of glass 13, building up an image of the fragmentation pattern, line by line. The fluorescent tube light source 7 is moved together with the line scan camera 6. This movement is in tandem. Once the line scan camera 6 has imaged the entire ply of glass 13, the drive means are and therefore the imaging rig are stopped. This is in the second position, at the opposite short side of the rectangular frame 3 from where the imaging rig 5 started the data collection run. Once the data has been collected, it is stored for future processing. Alternatively, the data may be processed during the data collection run. Data is processed using image analysis software capable of analysing the fragments at the resolution imaged.

Preferably, the line scan camera is one capable of a resolution of 0.2 mm/pixel, or particles sizes of 2.0 mm×2.0 mm, such as an L800k series camera available from Basler AG. A lens is used in conjunction with the camera to ensure 1:1 resolution, such that the camera has s wide enough field of view to image the entire width of the glass being measured. Other suitable image capture devices, such as CCD cameras may also be used. Whilst the light source is preferably a fluorescent tube emitting white light, other suitable light sources include a linear LED (light emitting diode) array, preferably emitting visible monochromatic light, such as red light, or a linear array of incandescent or other bulbs. The transparent support surface may be a ply of glass or transparent plastic material, such as polycarbonate, between 3-8 mm in thickness. Throughout the image capture process, the movement of the fluorescent tube light source 7 and the line scan camera 6 is preferably continuous, such that the images of the ply of glass 13 are obtained sequentially. The drive means carry the imaging rig at a minimum speed of 0.01 m/s, such that the fragmentation pattern on a ply of glass measuring 2.5 m×1.5 m can be imaged in 3 minutes. Preferably, the drive means carry the imaging rig at a speed of 0.5 m/s, allowing the glass to be imaged in approximately 1 minute. This has the advantage that further data collection passes can be made within the processing time window if necessary. The camera and light source combination are able to image fragmentation patterns in glass having a light transmission of as low as 13% (CIE Illuminant A) in that time. Preferably, the light transmission of the glass imaged is in the range 10% to 90%, more preferably 10% to 40% (all CIE Illuminant A), for glass having a thickness in the range 3 mm to 8 mm.

1. A method of inspecting a fragmentation pattern of a single ply of toughened glass, following a fragmentation test carried out in accordance with ECE R43, the method comprising:
positioning the ply of glass in contact with a flat transparent support means;
illuminating a first portion of the ply of glass in transmission using a strip light source located on a first side of the transparent support means;
capturing an image of the first portion of the ply of glass using an image capture device, the image capture device being located on a second side of the transparent support means, aligned with and fixed in a relative position to the strip light source;
moving the strip light source and the image capture device together along the length of the ply of glass, capturing an image from at least a second portion of the ply of glass; and
processing the images to determine the fragmentation pattern.

2. The method of claim 1, wherein sufficient images are captured to determine the fragmentation pattern over the entire ply of glass.

3. The method of claim 1, wherein the image capture device is a line scan camera.

4. The method of claim 1, wherein the strip light source is one of a fluorescent tube or a linear array of light emitting diodes or a linear array of incandescent bulbs.

5. The method of claim 1, wherein the movement of the light source and the image capture device comprises moving the light source and the image capture device in tandem.

6. The method of claim 1, wherein the movement of the light source and the image capture device comprises moving the light source and the image capture device continuously, and the capture of the images of the first and at least second portion of the ply of glass comprises capturing the images of the first and at least second portion of the ply of glass sequentially.

7. Optical inspection apparatus adapted to inspect fragmentation pattern of a single ply of toughened glass, following a fragmentation test carried out in accordance with ECE R43, the apparatus comprising:
a support frame having a flat transparent support means for supporting a ply of glass;
a strip light source located on a first side of the transparent support means;
an image capture device being located on a second side of the transparent support means, aligned with and fixed in a relative position to the strip light source; and
drive means mounted on the support frame to move the strip light source and the image capture device together along the length of the ply of glass.

8. The apparatus of claim 7, wherein the image capture device is a line scan camera.

9. The apparatus of claim 7, wherein the strip light source is one of a fluorescent tube or a linear array of light emitting diodes or a linear array of incandescent bulbs.

10. The apparatus of claim 7, wherein the light transmittance of the glass imaged, for glass in the thickness range 3 to 8 mm, is 10% to 90%, measured using CIE Illuminant A.

11. The apparatus of claim 7, wherein the light transmittance of the glass imaged, for glass in the thickness range 3 to 8 mm, is 10% to 40%, measured using CIE Illuminant A.

12. The method of claim 1, further comprising capturing additional images in addition to the image of the first portion and the second portion, the processing of the images comprising processing the additional images to determine the fragmentation pattern over the entire ply of glass.

13. The method of claim 12, wherein the image capture device is a line scan camera.

14. The method of claim 12, wherein the strip light source is one of a fluorescent tube or a linear array of light emitting diodes or a linear array of incandescent bulbs.

15. The method of claim 12, wherein the movement of the light source and the image capture device comprises moving the light source and the image capture device in tandem.

16. The method of claim 1, wherein the movement of the light source and the image capture device comprises moving the light source and the image capture device continuously, and the capture of the images of the first and at least second portion of the ply of glass comprises capturing the images of the first and at least second portion of the ply of glass sequentially.
